(19) United States
(12) Patent Application Publication
(10) Pub. No.: US 2006/0050375 A1
(43) Pub. Date: Mar. 9, 2006

(54) Confocal microscope

(75) Inventors: Kenta Mikuriya, Tokyo (JP); Takayuki Kei, Tokyo (JP); Takashi Yoshida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION

(21) Appl. No.: 11/210,656

(22) Filed: Aug. 25, 2005

(30) Foreign Application Priority Data
Sep. 9, 2004 (JP) P.2004-262610

(51) Int. Cl. G02B 21/06

(52) U.S. Cl. 359/385; 359/368

(57) ABSTRACT

A confocal microscope for performing an observation of a sample using a confocal image, the confocal microscope comprises a microscope, a confocal scanner of a Nipkow disk type, and a laser beam output section which is connected to the microscope and outputs a first laser beam for applying photic stimulation on the sample.

This application claims foreign priority based on Japanese Patent application No. 2004-262610, filed Sep. 9, 2004, the contents of which is incorporated herein by reference in its entirety.

### BACKGROUND OF THE INVENTION

1. Field of the Invention

The present invention relates to a confocal microscope, specifically relating to an improvement of a confocal microscope having a function of applying a photic stimulation on a sample to be observed.

2. Description of the Related Art

A confocal microscope observes a sample by scanning a converged light spot on the sample and imaging light returned from the sample so as to obtain an image. The confocal microscope is used in observing a physiological reaction or morphology of a living cell in the field of biology, biotechnology or the like, or observing a surface of LSI in a semiconductor market.

FIG. 4 is a configuration view showing an example of a confocal microscope of the related art.

In FIG. 4, a confocal scanner 110 is connected to a port 122 of a microscope 120. A laser beam 111 is converged to individual light fluxes by a microlens 117 of a microlens disk 112, and after transmitted through a dichroic mirror 113, passes through individual pin holes 116 of a pin hole disk (hereinafter, referred to as Nipkow disk) 114. Then the laser beam 111 is converged to a sample 140 on a stage 123 by an object lens 121 of the microscope 120.

A fluorescence signal coming out from the sample 140 passes the object lens 121 again, and is converged to the individual pin holes 116 of the Nipkow disk 114. The fluorescence signal passing through the individual pin holes 116 is reflected by the dichroic mirror 113, and is emitted from the confocal scanner 110 so as to be imaged on an image sensor 131 via a relay lens 115. In such an apparatus, the Nipkow disk 114 is rotated at a constant speed by a motor which is not illustrated, and a converged light spot on the sample 140 is scanned with the pin holes 116 moved by the rotation.

A plane of the Nipkow disk 114 on which the pin holes 116 are aligned, a plane to be observed for the sample 140, and a light receiving face of the image sensor 131 are arranged to be conjugate with each other optically. Therefore, an optical sectional image, that is, a confocal image of the sample 140 is imaged on the image sensor 131 (refer to, for example, JP-A-5-60980).

Further, other than the above-described confocal microscope of the Nipkow disk type, there is a confocal microscope that obtains a confocal image by performing scanning of a converged light spot on a sample by using a galvano mirror (refer to, for example, JP-A-5-210051).

In image measurement by using such a confocal microscope, there is a demand for applying a photic stimulation on a sample such as a cell and observing change in a state over an elapse of time (photoactivation, FRAP (fluorescence recovery after photobleaching) or the like). In photoactivation, for example, spot light of second laser other than laser beam for image measurement is irradiated onto a predetermined portion of the cell, and the portion is marked by changing a fluorescent color thereof. A behavior is observed of the mark spreading in the cell with an elapse of time.

Further, in FRAP (fluorescence recovery after photobleaching), fluorescence of a cell expressing fluorescent protein is partially bleached by irradiating second laser beam. A localized change of fluorescent protein after bleaching of the cell is observed.

However, the above-described confocal microscope of the Nipkow disk type of the related art is not provided with a function of applying a photic stimulation on a sample and observing a change thereof.

Further, in the confocal microscope of the galvano mirror type, time is taken in controlling a galvano mirror for two-dimensional scanning. There is a problem that it is difficult to perform image measurement in real time with regard to a high speed reaction of photic stimulation, fluorescence bleaching or the like.

### SUMMARY OF THE INVENTION

An object of the present invention is to realize a confocal microscope capable of observing a reaction of photic stimulation or fluorescence bleaching in real time. The object of the invention is realized by adding a function of applying photic stimulation to a confocal microscope of the Nipkow disk type, and performing a high-speed image measurement particular to a Nipkow disk type.

A confocal microscope for performing an observation of a sample using a confocal image, the confocal microscope comprises a microscope, a confocal scanner of a Nipkow disk type, and a laser beam output section which is connected to the microscope and outputs a first laser beam for applying photic stimulation on the sample.

The confocal microscope further comprises an adjustable diaphragm section which adjusts a diameter of a spot of the first laser beam.

The confocal microscope further comprises a scanning section which performs scanning with the first laser beam two-dimensionally.

In the confocal microscope, when the first laser beam is an invisible light, the laser beam output section synthesizes the first laser beam and a second laser beam for indicating a position at which the first laser beam is irradiated to the sample, and outputs the synthesized laser beam.

In the confocal microscope, the confocal microscope is used for photoactivation or fluorescence bleaching.

According to the invention, since the confocal microscope of the Nipkow disk type has the function of irradiating the laser beam for photic stimulation, photoactivation, FRAP or the like can be executed. Further, high speed performance (for example, scanning speed of 1000 frames/second) of the fluorescence observation, that is, the image measurement can be realized, because the image measurement is performed with using the confocal scanner of the Nipkow disk type. Accordingly, a high-speed reaction with regard to photic stimulation or fluorescence bleaching can be observed in real time.

According to the invention, the irradiation NA (numerical aperture) of the laser beam for photic stimulation is changed by providing the adjustable diaphragm section. Accordingly, a diameter of spot of photic stimulation becomes controllable, and a size of a range for applying photic stimulation can be changed.

According to the invention, photic stimulation corresponding with a shape of the sample can be applied by performing two-dimensional scanning with the laser beam for photic stimulation.

According to the invention, the laser beam for photic stimulation and the laser beam for indicating the position where the photic stimulation is applied are synthesized to irradiate the sample. Even when the laser beam for photic stimulation is ultraviolet ray, as a wavelength of fluorescence excited by the laser beam for indicating the position is of visible light, a point where photic stimulation is applied can be recognized visually.

### BRIEF DESCRIPTION OF THE DRAWINGS

FIG. 1 is a configuration view showing a first embodiment of a confocal microscope according to the invention.

FIG. 2 is a configuration view showing a second embodiment of a confocal microscope according to the invention.

FIG. 3 is a configuration view showing a third embodiment of a confocal microscope according to the invention.

FIG. 4 is a configuration view showing an example of a confocal microscope of a related art.

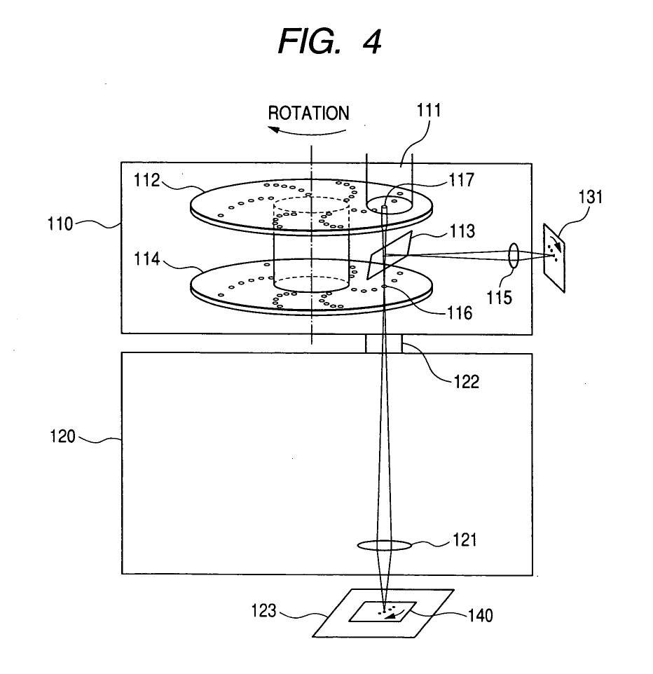

### DESCRIPTION OF THE PRFERRED EMBODIMENTS

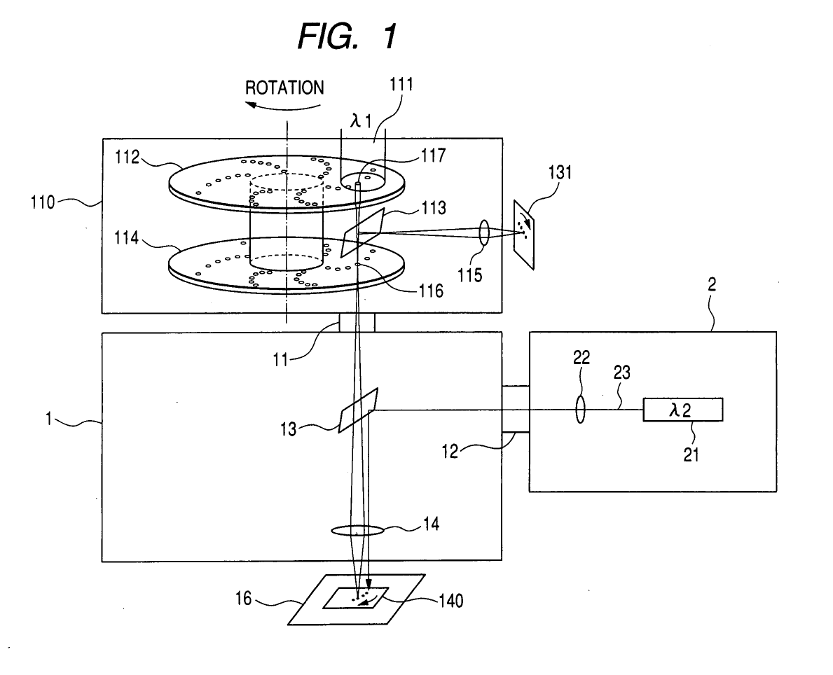

Embodiments of the invention will be explained in details in reference to the drawings as follows. FIG. 1 is a configuration view showing a first embodiment of a confocal microscope according to the invention. Constituent elements similar to those of the drawings previously shown are attached with similar notations, and an explanation of the elements will be omitted.

In FIG. 1, a first port 11 of the microscope 1 is attached with the confocal scanner 110 to constitute the confocal microscope for irradiating the laser beam 111 (first laser beam) having a wavelength of λ1 to the sample 140. The laser beam 111 entering the microscope 1 is converged to the sample 140 of a cell or the like on a stage 16 by an object lens 14 after transmitting through a dichroic mirror 13. The sample 140 emits fluorescence by irradiation of the laser beam 111. A fluorescence signal emitted from the sample 140 passes through the object lens 14 again, transmits through the dichroic mirror 13, and is imaged on the image scanner 131 via the confocal scanner 110 similar to the related art.

A second port 12 of the microscope 1 is attached with a laser beam output section 2. The laser beam output section 2 is provided with a laser beam source 21 and a collimator lens 22. The laser beam source 21 emits a second laser beam 23 having a wavelength of λ2, the collimator lens 22 converts the second laser beam 23 to parallel light and makes the second laser beam 23 to enter the microscope 1 through the second port 12. The second laser beam 23 entering the microscope 1 is reflected by the dichroic mirror 13, and a light beam spot of the laser beam for photic stimulation having the wavelength of λ2 is converged to the sample 140 by the object lens 14.

Further, a relationship between λ1 and λ2 in this case is λ2<λ1.

Since the confocal microscope of the Nipkow disk type has the function of irradiating the second laser beam for photic stimulation, an application of photoactivation, FRAP or the like can be executed. Further, high-speed performance (for example, scanning speed of 1000 frames/second) of the fluorescence observation, that is, the image measurement can be realized, because the image measurement is performed with using the confocal scanner of the Nipkow disk type. Therefore, a high-speed reaction with regard to photic stimulation or fluorescence bleaching can be observed in real time.

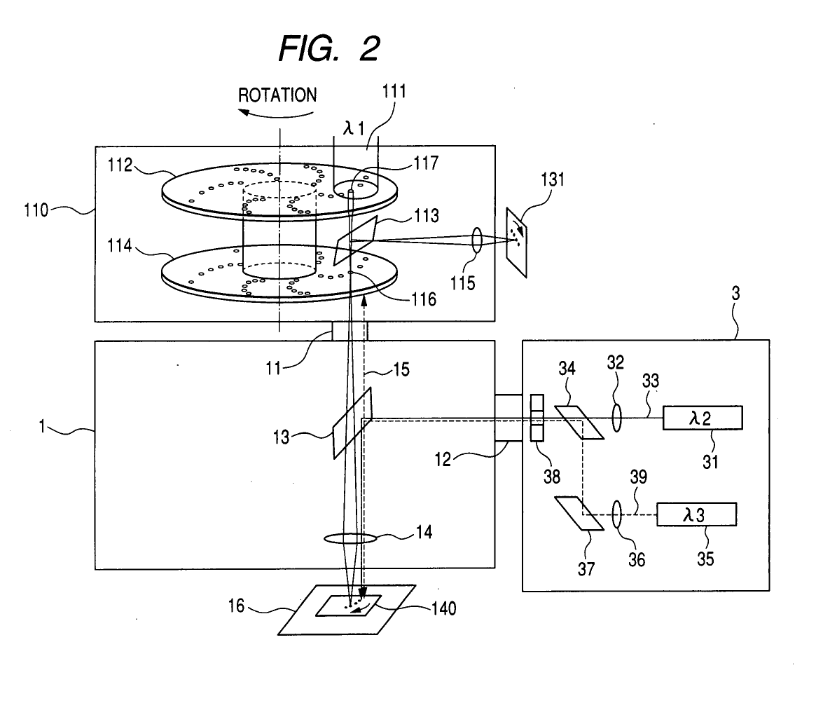

Here, in the configuration shown in FIG. 1, when the second laser beam 23 is not a visible light such as an ultraviolet ray, for example, an irradiating point of the second laser beam cannot be observed visually. In order to solve such a problem, as shown in FIG. 2, a laser spot of visible light is superposed on a beam spot of the second laser beam.

FIG. 2 is a configuration view showing a second embodiment according to the invention. Constituent elements similar to those of the drawings previously shown are attached with similar notations, and an explanation of the elements will be omitted.

In FIG. 2, the first port 11 of the microscope 1 is attached with the confocal scanner 110 to constitute the confocal microscope for irradiating the laser beam 111 having a wavelength of λ1 to the sample 140. The laser beam 111 entering inside the microscope 1 is converged to the sample 140 on the stage 16 by the object lens 14 after transmitting through the dichroic mirror 13. The sample 140 emits fluorescence by irradiation of the laser beam 111. A fluorescence signal emitted from the sample 140 passes through the object lens 14 again, transmits through the dichroic mirror 13, and is imaged on the image scanner 131 via the confocal scanner 110 similar to the related art.

The second port 12 of the microscope 1 is attached with a laser beam output section 3. The laser beam output section 3 is provided with laser beam sources 31, 35, collimator lenses 32, 36, a dichroic mirror 34, a total reflection mirror 37, and a adjustable diaphragm section 38.

The laser beam source 31 emits a second laser beam 33 having a wavelength of λ2 indicated by a solid line. The collimator lens 32 converts the second laser beam 33 into parallel light. The dichroic mirror 34 transmits the second laser beam 33 converted into parallel light by a spectroscopic characteristic thereof. A beam diameter of the second laser beam 33 transmitted through the dichroic mirror 34 can be changed by the adjustable diaphragm section 38. The second laser beam 33 passing through the adjustable diaphragm section 38 enters the microscope 1 from the second port 12 of the microscope 1. The second laser beam 33 entering the microscope 1 is reflected by the dichroic mirror 13, and a light beam spot of laser beam for photic stimulation having the wavelength of λ2 is imaged on the sample 140.

Further, the laser beam source 35 emits a third laser beam 39 having a wavelength of λ3 indicated by a broken line. The collimator lens 36 converts the third laser beam 39 into parallel light. The total reflection mirror 37 reflects the third laser beam 39 converted into parallel light so that the third laser beam 39 hits the dichroic mirror 34. The dichroic mirror 34, by the spectroscopic characteristic thereof, reflects the third laser beam 39 to enter the microscope 1 from the second port 12 via the adjustable diaphragm section 38. The third laser beam 39 entering the microscope 1 is reflected by the dichroic mirror 13, and a light beam spot having the wavelength of λ3 is imaged on the sample 140 by the object lens 14. Thereby, a second fluorescence signal 15 is generated. The second fluorescence signal 15 passes the object lens 14 again, transmits through the dichroic mirror 13, and is imaged on the image sensor 131 via the confocal scanner 110 similar to the fluorescence signal by laser beam 111. Further, a relationship of λ1, λ2, λ3 is constituted by λ2<λ1<λ3. Further, the second fluorescence signal 15 is visible light, and is provided with a wavelength longer than λ3.

The light having the wavelength λ2 and the light having the wavelength λ3 are synthesized to irradiate the sample 140. Therefore, even when the second laser beam (λ2) is ultraviolet light, so far as a wavelength of fluorescence excited by the third laser bean (λ3) is visible light, a point where photic stimulation is applied can be observed visually.

Further, an irradiation NA (numerical aperture) of the second and third laser beam are changed by providing the adjustable diaphragm section 38. Accordingly, a spot diameter of photic stimulation can be changed, and a size of a range for photic stimulation can be changed.

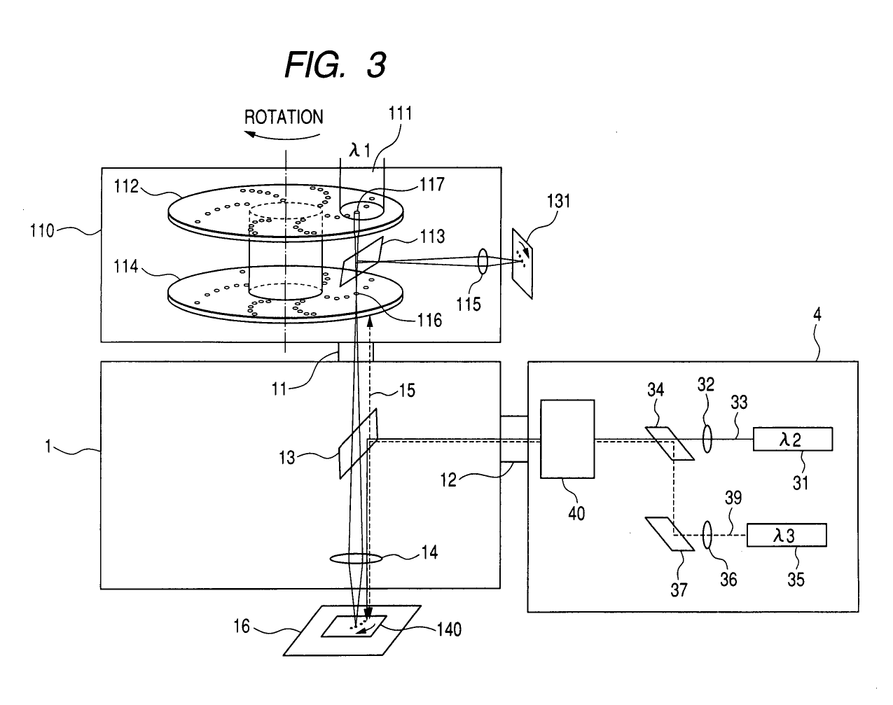

FIG. 3 is a configuration view showing a third embodiment according to the invention. Constituent elements similar to those of the drawings previously shown are attached with similar notations, and an explanation of the elements will be omitted.

In FIG. 3, configuration of the confocal scanner 110 and the microscope 1 are similar to those shown in FIG. 2 previously shown.

The second port 12 of the microscope 1 is attached with a laser beam output section 4. The laser beam output section 4 is provided with the laser beam sources 31, 35, the collimator lenses 32, 36, the dichroic mirror 34, the total reflection mirror 37, and a scanning section 40.

Configuration and operation of the laser beam sources 31, 35, the collimator lenses 32, 36, the dichroic mirror 34, and the total reflection mirror 37 are similar to those of the second embodiment shown in FIG. 2. The scanning section 40 is added to the configuration.

The scanning section 40 constitutes a scanning system of a mirror scan type. Although not illustrated, for example, scanning is performed with the laser beam two-dimensionally by using a galvano mirror. The galvano mirror is of a mechanism capable of being rotated in vertical and horizontal directions by a DC motor. Laser spot can be irradiated to a two-dimensional arbitrary position by rotating the galvano mirror with the control of the DC motor using a signal from a control unit.

The second and third laser beams 33, 39 outputted from the scanning section 40 enter the microscope 1, reflected by the dichroic mirror 13, converged by the object lens 14, and a spot light is irradiated on the sample 140. The second and third laser beams 33, 39 performs a two-dimensional scanning in the scanning section 40 so that photic stimulation corresponding with the shape of the sample 140 can be applied. Further, similar to the second embodiment, even when the second laser beam 33 for applying the photic stimulation is ultraviolet ray, a stimulated portion can be observed visually because of the third laser beam 39.

Further, the invention is not limited to the above-described embodiments but further includes a number of changes and modifications within the range not deviated from an essence thereof.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A confocal microscope for performing an observation of a sample using a confocal image, said confocal microscope comprising:
a microscope;
a confocal scanner of a Nipkow disk type; and
a laser beam output section which is connected to the microscope, and outputs a first laser beam for applying photic stimulation on the sample.

2. The confocal microscope as claimed in claim 1 further comprising:
an adjustable diaphragm section which adjusts a diameter of a spot of the first laser beam.

3. The confocal microscope as claimed in claim 1 further comprising:
a scanning section which performs scanning with the first laser beam two-dimensionally.

4. The confocal microscope as claimed in claim 1, wherein when the first laser beam is an invisible light, the laser beam output section synthesizes the first laser beam and a second laser beam for indicating a position at which the first laser beam is irradiated to the sample, and outputs the synthesized laser beam.

5. The confocal microscope as claimed in claim 4, wherein the second laser beam is a visible light.

6. The confocal microscope as claimed in claim 1, wherein the confocal microscope is used for photoactivation or fluorescence bleaching.
